(19) United States
(12) Patent Application Publication
(10) Pub. No.: US 2025/0380168 A1
(43) Pub. Date: Dec. 11, 2025

(54) TIMING FOR CSI REPORTING

(71) Applicant: Lenovo (Singapore) Pte. Limited, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 18/876,516

(22) PCT Filed: Jun. 13, 2023
(86) PCT No.: PCT/IB2023/056103

§ 371 Date: Dec. 18, 2024

Related U.S. Application Data
(60) Provisional application No. 63/353,900, filed on Jun. 21, 2022.

(51) Int. Cl. H04W 24/10; H04B 7/06; H04L 5/00

(52) U.S. Cl. CPC H04W 24/10; H04B 7/0639; H04L 5/005; H04L 5/0057

(57) ABSTRACT

Various aspects of the present disclosure relate to a user equipment (UE) that receives a channel state information (CSI) reporting setting. where the CSI reporting setting indicating CSI-reference signal (RS) transmissions over a channel measurement resource (CMR). The CSI-RS transmissions are associated with time units, and the CSI-RS transmissions correspond to two precoder matrix indicator (PMI) segments. The UE maps at least one PMI segment of the two PMI segments to the time units. and transmits a CSI report identifying the two PMI segments mapped to the time units.

### RELATED APPLICATION

This application claims priority to U.S. Provisional Application Ser. No. 63/353,900 filed Jun. 21, 2022 entitled “Timing for CSI Reporting”, the disclosure of which is incorporated by reference herein in its entirety.

### TECHNICAL FIELD

The present disclosure relates to wireless communications, and more specifically to channel state information (CSI) reporting.

### BACKGROUND

A wireless communications system may include one or multiple network communication devices, such as base stations, which may be otherwise known as an eNodeB (eNB), a next- generation NodeB (gNB), repeaters, radio heads, transceiver devices, access points, transmit-receive points, or other suitable terminology. Each network communication device, such as a base station may support wireless communications for one or multiple user communication devices, which may be otherwise known as user equipment (UE), a mobile device, a sensor device, a headset device, a wearable device, or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers, bandwidth parts, resource blocks, resource elements, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In a wireless communications system, CSI feedback is reported by a UE to the network, and the CSI feedback can take multiple forms based on the CSI feedback report size, time, and frequency granularity. A high-resolution CSI feedback report (Type-II) provides for a frequency granularity of the CSI feedback, which can be indirectly parametrized. The CSI reporting may be periodic or semi-persistent, and each CSI reporting segment associated by a pre-defined rule with a CSI-reference signal (RS) transmission of the periodic or semi-persistent CSI-RS transmissions (i.e., CSI reporting and CSI-RS transmissions are associated with the same time-domain behavior). Further, one CSI report corresponds to multiple CSI-RS transmissions according to the periodic or semi-persistent CSI-RS transmissions, and the CSI report is divided into multiple segments with each CSI report segment associated with a distinct CSI-RS transmission.

### SUMMARY

The present disclosure relates to methods, apparatuses, and systems that support timing for CSI reporting. By utilizing the described techniques, a UE can be configured for reporting a CSI report that includes a mixture of CSI reporting corresponding to prior CSI (e.g., prior CSI corresponding to time instants that precede the CSI report transmission in the uplink direction), and CSI reporting corresponding to future CSI (e.g., predicted CSI corresponding to time instants that follow the CSI report transmission in the uplink direction). The CSI report can be decomposed into multiple CSI report segments, where each CSI report segment includes CSI report quantities associated with a distinct time range and/or time interval. Further, an indication of the time intervals corresponding to each CSI report segment can be reported, where the indication is configured by the network to the UE via higher-layer signaling, fed back by the UE to the network as part of the CSI report, or a combination thereof. By performing timing for CSI reporting, a UE can operate in a wireless communications system at relatively high-speeds of travel when taking into consideration the timing indication of CSI quantities for CSI reporting in the high-speed environment.

Some implementations of the method and apparatuses described herein may further include a UE receives a first signaling indicating a CSI reporting setting, which indicates CSI-RS transmissions over a channel measurement resource (CMR). The CSI-RS transmissions are associated with time units, and the CSI-RS transmissions correspond to two precoder matrix indicator (PMI) segments. The UE maps at least one PMI segment of the two PMI segments to the time units, and transmits a second signaling indicating a CSI report identifying the at least one PMI segment of the two PMI segments mapped to the time units. Each of the PMI segments includes a set of coefficients, and each PMI segment is associated with at least one of the CSI-RS transmissions.

Some implementations of the method and apparatuses described herein may further include a network device (e.g., a base station) that transmits a first signaling indicating a CSI reporting setting, which indicates CSI-RS transmissions over a CMR. The CSI-RS transmissions are associated with time units, and the CSI-RS transmissions correspond to two PMI segments. The network device receives a second signaling indicating a CSI report that identifies a mapping of at least one PMI segment of the two PMI segments mapped to the time units. Each of the PMI segments includes a set of coefficients, and each PMI segment is associated with at least one of the CSI-RS transmissions.

Some implementations of the method and apparatuses described herein may further include a UE receiving a first signaling indicating a CSI reporting setting, the CSI reporting setting indicating CSI-RS transmissions over a CMR, the CSI-RS transmissions associated with time units, and the CSI-RS transmissions corresponding to two PMI segments. The UE mapping at least one PMI segment of the two PMI segments to the time units, and the UE transmitting a second signaling indicating a CSI report that identifies the at least one PMI segment of the two PMI segments mapped to the time units.

Some implementations of the method and apparatuses described herein may further include a network device (e.g., a base station) transmitting a first signaling indicating a CSI reporting setting, the CSI reporting setting indicating CSI-RS transmissions over a CMR, the CSI-RS transmissions associated with time units, and the CSI-RS transmissions corresponding to two PMI segments. The network device receiving a second signaling indicating a CSI report that identifies a mapping of at least one PMI segment of the two PMI segments mapped to the time units.

### BRIEF DESCRIPTION OF THE DRAWINGS

FIG. 1 illustrates an example of a wireless communications system that supports timing for CSI reporting in accordance with aspects of the present disclosure.

FIG. 2 illustrates an example of aperiodic trigger state defining a list of CSI report settings as related to timing for CSI reporting in accordance with aspects of the present disclosure.

FIG. 3 illustrates an example of aperiodic trigger state that indicates the resource set and quasi co-located (QCL) information as related to timing for CSI reporting in accordance with aspects of the present disclosure.

FIG. 4 illustrates an example of a RRC configuration for a non-zero power (NZP)-CSI-RS resource as related to timing for CSI reporting in accordance with aspects of the present disclosure.

FIG. 5 illustrates an example of a partial CSI omission for physical uplink shared channel (PUSCH)-based CSI as related to timing for CSI reporting in accordance with aspects of the present disclosure.

FIG. 6 illustrates an example of ASN.1 code corresponding to an indication of CSI reporting in a high-speed environment that supports timing for CSI reporting in accordance with aspects of the present disclosure.

FIG. 7 illustrates an example of ASN.1 code corresponding to an indication of CSI reporting in a high-speed environment that supports timing for CSI reporting in accordance with aspects of the present disclosure.

FIG. 8 illustrates an example of ASN.1 code corresponding to an indication of CSI reporting in a high-speed environment that supports timing for CSI reporting in accordance with aspects of the present disclosure.

FIGS. 9 and 10 illustrate an example of a block diagram of a device that supports timing for CSI reporting in accordance with aspects of the present disclosure.

FIGS. 11 and 12 illustrate flowcharts of methods that support timing for CSI reporting in accordance with aspects of the present disclosure.

### DETAILED DESCRIPTION

In a wireless communications system, CSI feedback is reported by a UE to the network, and the CSI feedback can take multiple forms based on the CSI feedback report size, time, and frequency granularity. The CSI reporting may be periodic or semi-persistent, and each CSI reporting segment associated by a pre-defined rule with a CSI-RS transmission of the periodic or semi-persistent CSI-RS transmissions (i.e., CSI reporting and CSI-RS transmissions are associated with the same time-domain behavior). However, this approach is limited to network-based CSI prediction only. Providing a CSI report for each CSI-RS transmission is not efficient if the channel correlation corresponding to two consecutive CSI-RS transmissions is strong. Further, one CSI report corresponds to multiple CSI-RS transmissions according to the periodic or semi-persistent CSI-RS transmissions, and the CSI report is divided into multiple segments with each CSI report segment associated with a distinct CSI-RS transmission. However, given a network-based CSI prediction assumption, the reported CSI quantities can be stale (e.g., less correlated to the channel by the time of CSI feedback), particularly for CSI report segments that are associated with earlier CSI-RS transmissions. For UE-based CSI prediction, each CSI report may correspond to a distinct time instant in the future, however, coordination between the network and the UE (e.g., a network-based indication, a UE-assisted indication, or a fixed rule) is needed to identify the time correspondence of the CSI reports.

Aspects of timing for CSI reporting take into consideration scenarios in which the UE speed is relatively high (e.g., up to 500 km/h), such as when traveling in an auto, train, or other conveyance. In order to accommodate such scenarios, while maintaining similar quality of service, a modified CSI framework that includes measurement and reporting can be implemented. At relatively higher speeds (e.g., relative to a UE that is generally stationary or at a fixed location, or moving slowly), a CSI report may indicate prior CSI corresponding to past time instants (e.g., at time instants that are before the CSI reporting time), where a CSI prediction is determined by the network based on the prior CSI, or predicted CSI corresponding to future time instants (e.g., time instants that are after the CSI reporting time), where the CSI prediction is determined at the UE. For either type of CSI prediction, the CSI reporting may correspond to a variety of time instants. Further, full coordination on the mapping of the CSI report quantities to the respective time instants is considered for more efficient exploitation of the reported CSI for network-side precoder design.

Aspects of the disclosure provide CSI framework solutions for both measurement and reporting, such as configurations for UEs moving with high speed. At high speeds (e.g., relative high speeds), a UE may need to report CSI corresponding to one or more time instants to enable efficient prediction of the CSI due to the strong Doppler effect at the high speeds. A UE can provide a CSI report that includes a mixture of CSI reporting corresponding to prior CSI (e.g., prior CSI corresponding to time instants that precede the CSI report transmission in the uplink direction), and CSI reporting corresponding to future CSI (e.g., predicted CSI corresponding to time instants that follow the CSI report transmission in the uplink direction). The CSI report can be decomposed into multiple CSI report segments, where each CSI report segment includes CSI report quantities associated with a distinct time range and/or time interval. Further, an indication of the time intervals corresponding to each CSI report segment can be reported, where the indication is configured by the network to the UE via higher-layer signaling, fed back by the UE to the network as part of the CSI report, or a combination thereof.

Aspects of the present disclosure are described in the context of a wireless communications system. Aspects of the present disclosure are further illustrated and described with reference to device diagrams and flowcharts.

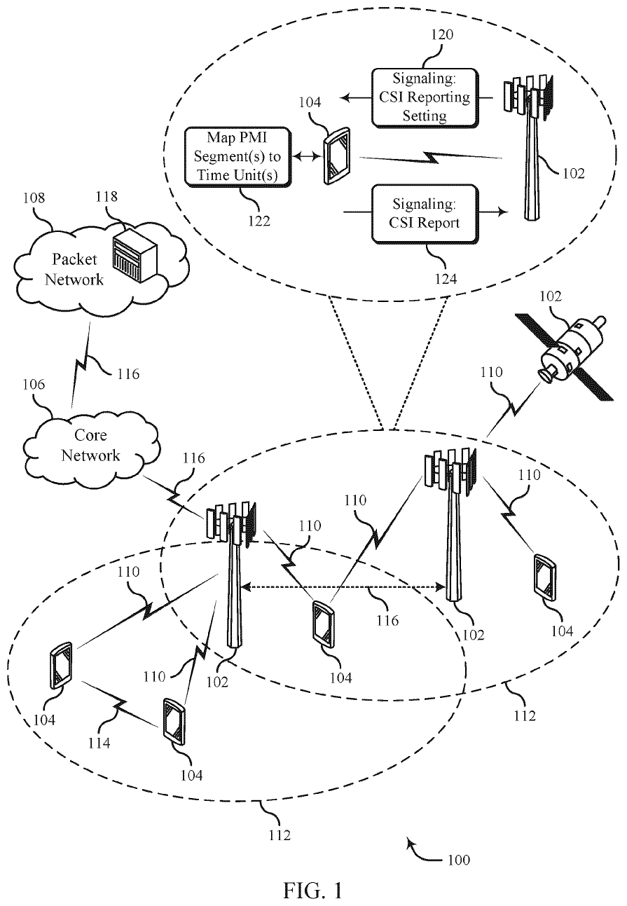

FIG. 1 illustrates an example of a wireless communications system 100 that supports timing for CSI reporting in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a

NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of timing for CSI reporting, as described herein. For instance, a network entity 102 can communicate a signaling 120 indicating a CSI reporting setting, where the CSI reporting setting indicates CSI-RS transmissions over a CMR. The CSI-RS transmissions are associated with time units, and the CSI-RS transmissions correspond to two PMI segments. A UE 104 receives the signaling 120 and maps 122 at least one PMI segment of the two PMI segments to the time units. The UE 104 transmits a response signaling 124 to the network entity 102, where the signaling 124 indicates a CSI report identifying the at least one PMI segment of the two PMI segments mapped to the time units. Accordingly, the network entity 102 receives the signaling 124 that indicates the CSI report.

In aspects of timing for CSI reporting, new radio (5GNR) codebook types are taken into consideration, such as Type-II Codebook. With reference to NR (Rel. 15) Type-II codebook, a gNB can be equipped with a two-dimensional (2D) antenna array with N₁, N₂ antenna ports per polarization placed horizontally and vertically, and communication occurs over N₃ PMI sub-bands. A PMI sub-band consists of a set of resource blocks, with each resource block consisting of a set of subcarriers. In this case, 2N₁N₂ CSI-RS ports are utilized to enable downlink (DL) channel estimation with high resolution for NR (Rel. 15) Type-II codebook. In order to reduce the uplink (UL) feedback overhead, a discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N_{2X}N₃ codebook per layer/takes on the form:

$${W}_{l} = {W}_{1} {W}_{2 , l} ,$$

where W₁ is a 2N₁N_{2X}2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N_{2X}L matrix with columns drawn from a 2D oversampled DFT matrix, as follows:

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}} ]}\end{matrix} \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ B = [ \begin{matrix}{v}_{{l}_{0} , {m}_{0}} & {v}_{{l}_{1} , {m}_{1}} & … & {v}_{{l}_{L - 1} , {m}_{L - 1}} ]\end{matrix} \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2}\end{matrix}$$

where the superscript T denotes a matrix transposition operation. Note that O₁, O₂ oversampling factors are assumed for the 2D DFT matrix from which matrix B is drawn. Note that W₁ is common across all layers. W_{2,1} is a 2Lx N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,1} are independent for different layers.

With reference to NR (Rel. 15) Type-II Port Selection codebook, only K (where K≤2N₁N₂) beamformed CSI-RS ports are utilized in DL transmission, in order to reduce complexity. The KxN₃ codebook matrix per layer takes on the form:

$${W}_{l} = {W}_{1}^{PS} {W}_{2 , l} .$$

Here, W₂ follow the same structure as the conventional NR Type-II Codebook, and are layer specific.

$${W}_{1}^{PS}$$

is a Kx2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1, 2, 3, 4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . ,7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0, 1, 2, 3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0, 1, 2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0, 1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

With reference to NR (Rel. 15) Type-I codebook, the Type-I codebook is the baseline codebook for NR, with a variety of configurations. The most common utility of the Type-I codebook is a special case of NR Type-II codebook with L=1 for rank indicator (RI)=1,2, wherein a phase coupling value is reported for each sub-band, i.e., W_{2,1} is 2xN₃, with the first row equal to [1, 1, . . . , 1] and the second row equal to [e^{j2π∅}^{₀}, . . . , e^{j2π∅}^{_{N3−1}}]. Under specific configurations, ϕ₀=ϕ₁ . . . =ϕ, i.e., wideband reporting. For RI>2 different beams are used for each pair of layers. The NR Type-I codebook can be depicted as a low-resolution version of NR Type-II codebook with spatial beam selection per layer-pair and phase combining only.

With reference to NR (Rel. 16) Type-II codebook, a gNB can be equipped with a two-dimensional (2D) antenna array with N₁, N₂ antenna ports per polarization placed horizontally and vertically and communication occurs over N₃ PMI sub-bands. A PMI sub-band consists of a set of resource blocks, with each resource block consisting of a set of subcarriers. In this case, 2N₁N₂N₃ CSI-RS ports are utilized to enable DL channel estimation with high resolution for NR (Rel. 16) Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N_{2X}N₃ codebook per layer takes on the form:

$${W}_{l} = {W}_{1} {\tilde{W}}_{2 , l} {W}_{f , l}^{H} ,$$

where W₁ is a 2N₁N_{2X}N2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N_{2X}L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{{O}_{1} {N}_{1}}_{}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N_{3X}M matrix (M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred to as the selected frequency domain (FD) basis indices. Hence, L, M represent the equivalent spatial and frequency dimensions after compression, respectively. Finally, the 2LxM matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N_{2X}N₃₋₁ coefficients' information.

For the Type-II Port Selection codebook (Rel. 16), only K (where K≤2N₁N₂) beamformed CSI-RS ports are utilized in DL transmission, in order to reduce complexity. The KxN₃ codebook matrix per layer takes on the form:

$${W}_{l} = {W}_{1}^{PS} {\tilde{W}}_{2 , l} {W}_{f , l}^{H} .$$

Here, \tilde{W}_{2,1} and W_{f,l} follow the same structure as the conventional NR (Rel. 16) Type-II Codebook, where both are layer specific. The matrix

$${W}_{1}^{PS}$$

is a Kx2L block-diagonal matrix with the same structure as that in the NR (Rel. 15) Type-II Port Selection codebook.

For codebook reporting, the codebook report is partitioned into two parts based on the priority of information reported. Each part is encoded separately (Part 1 has a possibly higher code rate). Below, only the parameters for NR (Rel. 16) Type-II codebook are listed. With reference to the content of a CSI report, a Part 1 is RI+channel quality indicator (CQI)+total number of coefficients. A Part 2 is SD basis indicator+FD basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the UL phase. Additionally, Type-II codebook is based on aperiodic CSI reporting, and only reported in PUSCH via downlink control information (DCI) triggering (one exception). Type-I codebook can be based on periodic CSI reporting (physical uplink control channel (PUCCH)) or semi-persistent CSI reporting (physical uplink shared channel (PUSCH) or PUCCH) or aperiodic reporting (PUSCH).

With reference to reporting CSI report Part 2, note that multiple CSI reports may be transmitted with different priorities, as shown below in Table 1.

TABLE 1
Priority Reporting Levels for Part 2 CSI.
Priority 0:
For CSI reports 1 to N_{Rep}, Group 0 CSI for CSI reports
configured as ‘typeII-r16’ or ‘typeII-PortSelection-r16’; Part 2
wideband CSI for CSI reports configured otherwise
Priority 1:
Group 1 CSI for CSI report 1, if configured as ‘typeII-r16’ or
‘typeII-PortSelection-r16’; Part 2 sub-band CSI of even
sub-bands for CSI report 1, if configured otherwise
Priority 2:
Group 2 CSI for CSI report 1, if configured as ‘typeII-r16’ or
‘typeII-PortSelection-r16’; Part 2 sub-band CSI of odd
sub-bands for CSI report 1, if configured otherwise
Priority 3:
Group 1 CSI for CSI report 2, if configured as ‘typeII-r16’ or
‘typeII-PortSelection-r16’; Part 2 sub-band CSI of even
sub-bands for CSI report 2, if configured otherwise
Priority 4:
Group 2 CSI for CSI report 2, if configured as ‘typeII-r16’ or
‘typeII-PortSelection-r16’. Part 2 sub-band CSI of odd
sub-bands for CSI report 2, if configured otherwise
.
.
.
Priority 2N_{Rep} − 1:
Group 1 CSI for CSI report N_{Rep}, if configured as ‘typeII-r16’
or ‘typeII-PortSelection-r16’; Part 2 sub-band CSI of even
sub-bands for CSI report N_{Rep}, if configured otherwise
Priority 2N_{Rep}:
Group 2 CSI for CSI report N_{Rep}, if configured as ‘typeII-r16’
or ‘typeII-PortSelection-r16’; Part 2 sub-band CSI of odd
sub-bands for CSI report N_{Rep}, if configured otherwise

With reference to triggering aperiodic CSI reporting on PUSCH, a UE needs to report the needed CSI information for the network using the CSI framework in NR (Rel. 15). The triggering mechanism between a report setting and a resource setting can be summarized as shown below in Table 2.

TABLE 2
Triggering mechanism between a report
setting and a resource setting.

| | | Periodic | | |
|---|---|---|---|---|
| | | CSI | SP CSI | AP CSI |
| | | reporting | reporting | Reporting |
| Time | Periodic | RRC | MAC CE (PUCCH) | DCI |
| Domain | CSI-RS | configured | DCI (PUSCH) | |
| Behavior | SP CSI-RS | Not | MAC CE (PUCCH) | DCI |
| of Resource | | Supported | DCI (PUSCH) | |
| Setting | AP CSI-RS | Not | Not Supported | DCI |
| | | Supported | | |

Moreover, all associated resource settings for a CSI report setting need to have the same time domain behavior. Periodic CSI-RS/interference management (IM) resource and CSI reports are assumed to be present and active once configured by radio resource control (RRC). Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

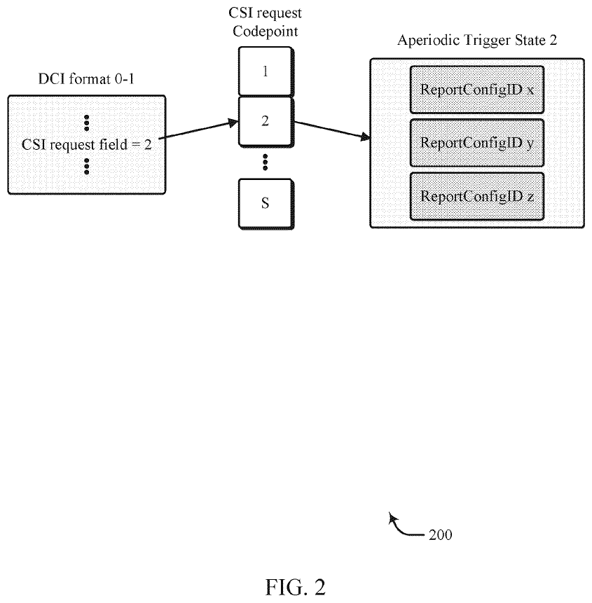

FIG. 2 illustrates an example 200 of aperiodic trigger state defining a list of CSI report settings as related to timing for CSI reporting in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting identifier (ID) for which the UE calculates simultaneously CSI and transmits it on the scheduled PUSCH transmission.

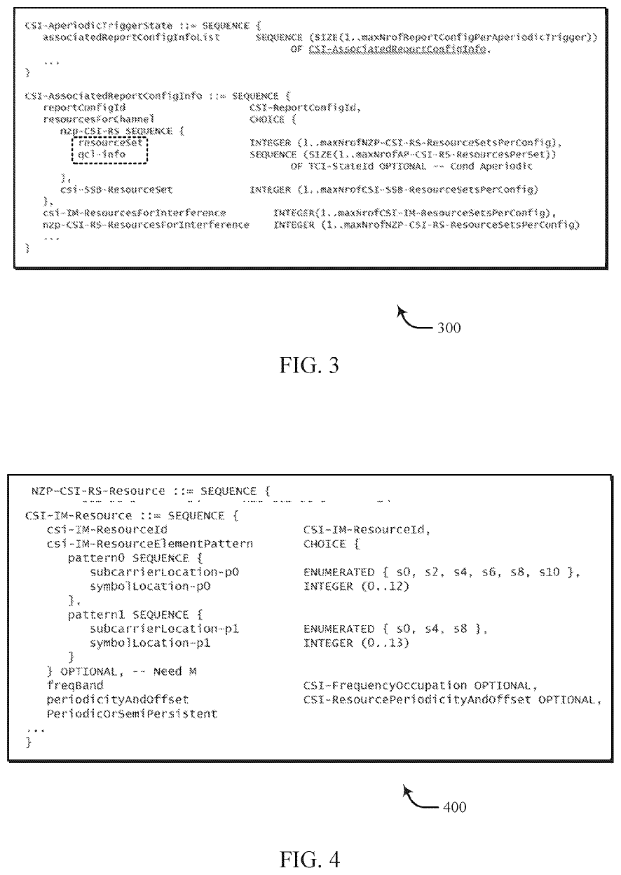

FIG. 3 illustrates an example 300 of aperiodic trigger state that indicates the resource set and QCL information as related to timing for CSI reporting in accordance with aspects of the present disclosure. This example 300 indicates that when the CSI report setting is linked with an aperiodic resource setting (which may include multiple resource sets), the aperiodic NZP CSI-RS resource set for channel measurement, the aperiodic CSI-IM resource set (if used), and the aperiodic NZP CSI-RS resource set for IM (if used) to use for a given CSI report setting are also included in the aperiodic trigger state definition, as shown in this example 300. For aperiodic NZP CSI-RS, the QCL source to use is also configured in the aperiodic trigger state. The UE assumes that the resources used for the computation of the channel and interference can be processed with the same spatial filter (i.e. quasi-co-located with respect to “QCL-TypeD”).

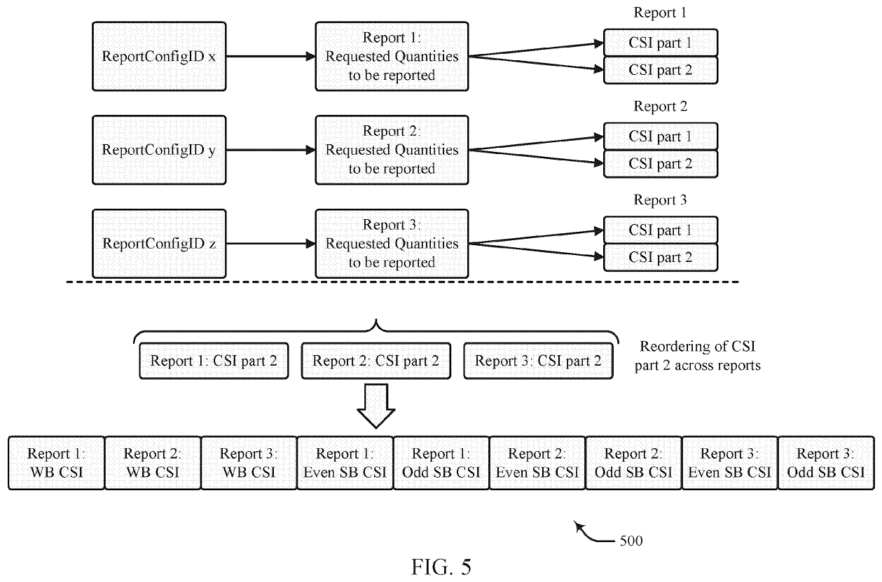

FIG. 4 illustrates an example 400 of a RRC configuration for a NZP-CSI-RS resource as related to timing for CSI reporting in accordance with aspects of the present disclosure. This example 400 indicates the RRC configuration for NZP-CSI-RS/CSI-IM resources. A Table 3 below summarizes the type of UL channels used for CSI reporting as a function of the CSI codebook type.

TABLE 3
UL channels used for CSI reporting as
a function of the CSI codebook type.

| | Periodic CSI | SP CSI | AP CSI |
|---|---|---|---|
| | reporting | reporting | reporting |
| Type I WB | PUCCH Format | PUCCH | PUSCH |
| | 2, 3, 4 | Format 2 | |
| | | PUSCH | |
| Type I SB | | PUCCH | PUSCH |
| | | Format 3, 4 | |
| | | PUSCH | |
| Type II WB | | PUCCH | PUSCH |
| | | Format 3, 4 | |
| | | PUSCH | |
| Type II SB | | PUSCH | PUSCH |
| Type II | | PUCCH | |
| Part 1 only | | Format 3, 4 | |

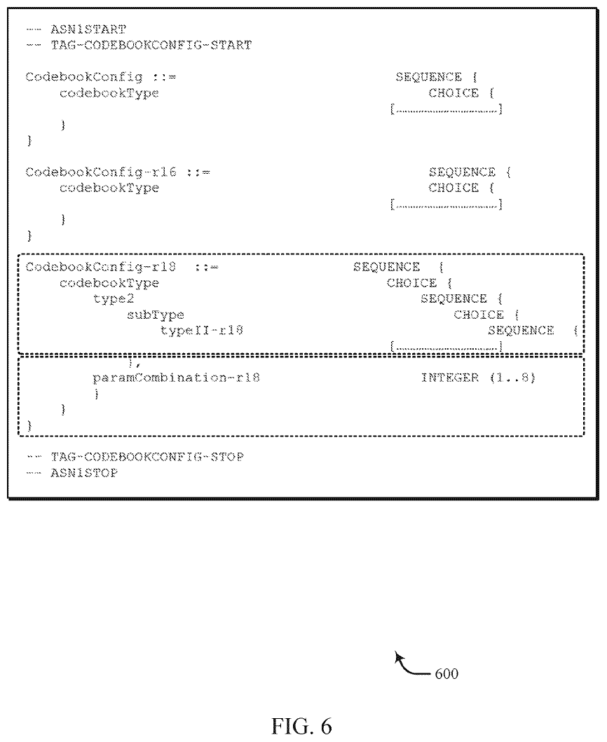

FIG. 5 illustrates an example 500 of a partial CSI omission for PUSCH-based CSI as related to timing for CSI reporting in accordance with aspects of the present disclosure. For aperiodic CSI reporting, PUSCH-based reports are divided into two CSI parts, CSI Part1 and CSI Part 2, because the size of CSI payload varies significantly, and therefore a worst-case uplink control information (UCI) payload size design would result in large overhead. CSI Part 1 has a fixed payload size (and can be decoded by the gNB without prior information) and contains the following: RI (if reported), CSI-RS resource index (CRI) (if reported), and CQI for the first codeword; and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e. L1-reference signal received power (RSRP) reporting) has priority over regular CSI reports; the serving cell to which the CSI corresponds (in case of carrier aggregation (CA) operation), and CSI corresponding to the PCell has priority over CSI corresponding to Scells; and the reportConfigID).

In aspects of timing for CSI reporting as described herein, unless otherwise stated, a group of one or more NZP CSI-RS resources configured with a higher-layer parameter ‘trs-info’ is referred by a tracking reference signal (TRS), and an NZP CSI-RS resource that is not configured with either higher-layer parameters ‘trs-info’ or ‘repetition’ is referred to as CSI-RS. Aspects of the present disclosure for CSI reporting in a high-speed environment, a UE is expected to be a configured with a CSI reporting setting (i.e., a CSI-ReportConfig information element (IE)) that corresponds to CSI feedback in a high-mobility environment. Note that the CSI reporting in a high-speed environment is not tied to a specific speed, but rather based on signaling between the network and a UE to activate a specific mode. An indication of the high-mobility environment within the CSI reporting setting can be implemented with one or more techniques, as described following.

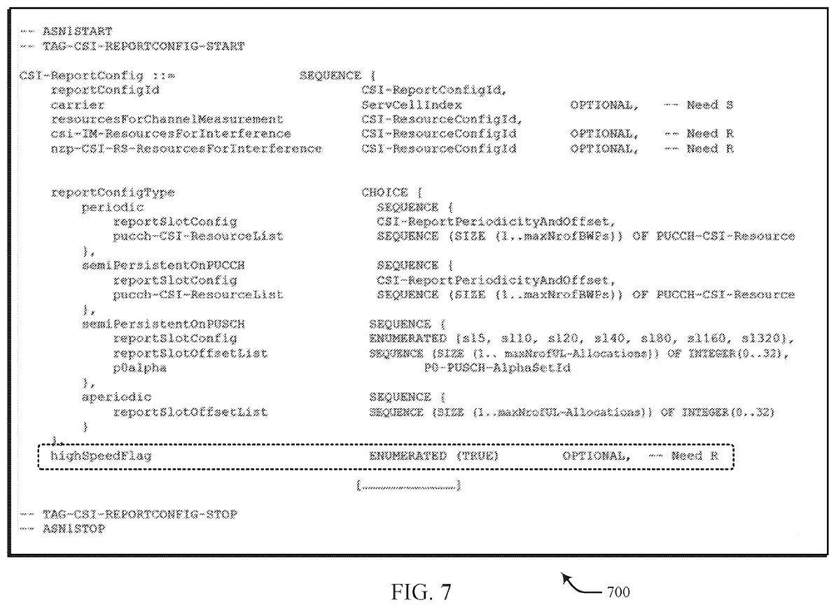

FIG. 6 illustrates an example 600 of ASN.1 code corresponding to an indication of CSI reporting in a high-speed environment that supports timing for CSI reporting in accordance with aspects of the present disclosure. In an implementation of this example 600 of a new codebook type, or sub-type, one or more additional values to the higher-layer parameter CodebookType can be introduced. In an implementation, the parameter CodebookType may be part of one or more codebook configuration IEs. Alternatively, a new codebook configuration can be implemented (introduced in Rel. 18, i.e., CodebookConfig-r18). All the codebook configuration IEs are part of the CSI-ReportConfig reporting setting IE. Examples of the additional values of the CodebookType parameter are ‘typeII-r18’, or ‘typeII-HighSpeed’. An example of the ASN.1 code that corresponds to the implementations described herein is shown in this example 600 for the codebook configuration IE.

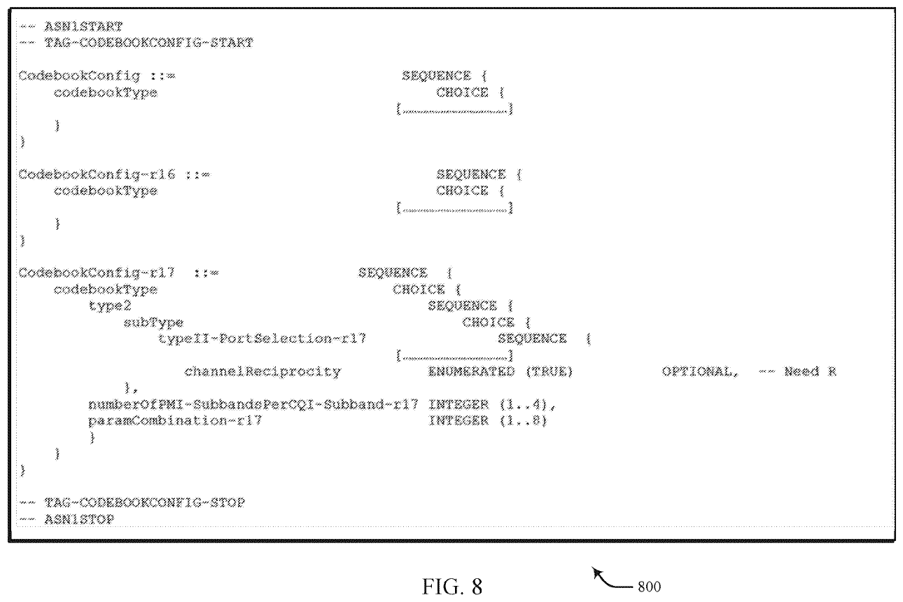

FIG. 7 illustrates an example 700 of ASN.1 code corresponding to an indication of CSI reporting in a high-speed environment that supports timing for CSI reporting in accordance with aspects of the present disclosure. In an implementation of this example 700, an additional higher layer parameter (e.g., highSpeed) is introduced as part of the CSI reporting setting within the CSI reporting setting IE that configures the UE with CSI feedback reporting corresponding to a high-speed environment. The high-speed parameter may appear in different sub-elements of the reporting setting IE. An example of the ASN.1 code that corresponds to this embodiment is shown in this example 700 for the CSI reporting setting IE.

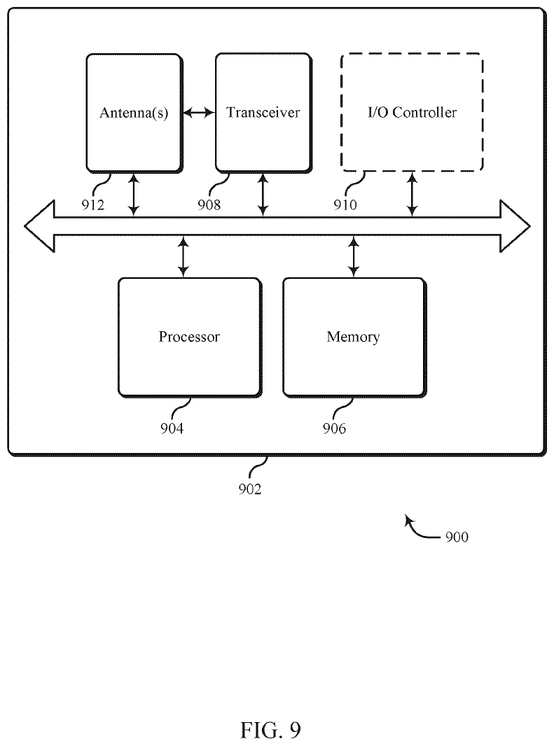

FIG. 8 illustrates an example 800 of ASN.1 code corresponding to an indication of CSI reporting in a high-speed environment that supports timing for CSI reporting in accordance with aspects of the present disclosure. In an implementation of this example 800, an additional higher layer parameter (e.g., highSpeedFlag) is introduced within the codebook configuration CodebookConfig IE as part of the codebook configuration. In a first example, the new parameter is included under the codebook configuration IE (e.g., CodebookConfig, CodebookConfig-r18). In a second example, the new parameter is a sub-parameter within the higher-layer parameter codebookType, which is a configuration conditioned on the support of the high-speed codebook (e.g., whenever the codebook type is set to Rel. 18 Type-II, e.g., ‘typeII-r18’, ‘typeII-HighSpeed’). An example of the ASN.1 code that corresponds to this implementation is shown in the example 800 for the CodebookConfig codebook configuration information element (IE).

With reference to CSI reporting configuration, a UE is expected to be a configured with a CSI reporting setting as a message from the network (i.e., CSI-ReportConfig information element (IE)), that corresponds to CSI feedback in a high-mobility environment. Several implementations are described below, any one or combination of which may be implemented in aspects of timing for CSI reporting. In a first implementation for periodic or semi-persistent CSI-RS transmission, the CSI reporting setting is associated with a CSI resource setting (i.e., CSI-ResourceConfig) that is configured with a time-domain behavior set to one of a periodic CSI-RS transmission or a semi-persistent CSI-RS transmission. In a second implementation for two CSI-RS transmission modes, periodic or semi-persistent, and aperiodic CSI-RS transmission, the CSI reporting setting is associated with a CSI resource setting (i.e., CSI-ResourceConfig) corresponding to two CSI-RS groups. A first CSI-RS resource group is configured with a time-domain behavior that is set to one of a periodic CSI-RS transmission or a semi-persistent CSI-RS transmission, and a second CSI-RS resource group is configured with a time-domain behavior that is set to an aperiodic CSI-RS transmission.

In a third implementation, the UE is configured to report at least two PMI segments within a same CSI report. For example, each PMI segment of the two PMI segments corresponds to a distinct PMI quantity based on a configured precoding matrix. In another example, the two PMI segments correspond to different parameters of a same PMI quantity based on a configured precoding matrix. With respect to content of the two PMI segments, and in a fourth implementation, a first of the two PMI segments includes a first subset of a set of precoding matrix coefficient values, where the first subset of the set of precoding matrix coefficient values includes a first set of amplitude values, phase values, and bitmap values that indicate or locate coefficients with non-zero amplitude values. A second of the two PMI segments includes a second subset of a set of precoding matrix coefficient values, where the second subset of the set of precoding matrix coefficient values includes a second set of amplitude values, phase values, and bitmap values that indicate or locate coefficients with non-zero amplitude values.

In implementations, the two PMI segments can be associated with a common RI value. The two PMI segments can be associated with a common CQI value. In an implementation, a first of the two PMI segments are associated with CQI value(s) that are configured with a sub-band CQI format, and the second of the two PMI segments are associated with CQI value(s) that are configured with a wideband CQI format. In another implementation, the first of the two PMI segments is associated with PMI value(s) that are configured with a sub-band PMI format, and the second of the two PMI segments is associated with PMI value(s) that are configured with a wideband PMI format.

With respect to an indication of the time instants corresponding to PMI segments, a UE may be configured with transmitting a CSI report that includes at least two PMI segments, and may need to communicate an indication of two PMI intervals corresponding to the two PMI segments. The UE would report one CSI (e.g., at time z). However, this one-shot CSI report would include CSI corresponding to multiple times, x & y (e.g., x=5, y=7, and z=10). Several implementations are described below, any one or combination of which may be implemented in aspects of timing for CSI reporting.

With respect to a network device that determines time units corresponding to the two PMI segments, the UE receives the configuration information that indicates a set of one or more time units or intervals, where each time unit or interval corresponds to at least one PMI segment of the two PMI segments, and the configuration indication is based on RRC signaling or MAC CE signaling.

In another implementation, the UE determines the time units corresponding to the two PMI segments, and the UE returns a parameter value that indicates a set of one or more time units or intervals, where each time unit or interval corresponds to at least one PMI segment of the two PMI segments. The parameter value is reported over a physical uplink channel (e.g., a PUSCH or PUCCH) as part of a CSI report corresponding to high-speed scenarios. In another implementation, with reference to an alphabet of time units that can be selected by the UE or the network, the alphabet of time units or intervals correspond to any one or combination of: a group of consecutive slots (e.g., an interval of five (5) consecutive slots); a group of non-consecutive slots with equal time spacing (e.g., slots 0, 4, 9, 14, . . . ); a group of pre-configured sequence of slots; and/or a one-to-one correspondence with a time-domain behavior of a corresponding CSI-RS transmission (e.g., each PMI segment is based on one CSI-RS transmission of a periodic CSI-RS transmission).

In another implementation, a CSI report includes a number (e.g., K, of PMI segments indicating the same number, i.e., K, of time units or intervals), as K time values for K PMI segments. In another implementation, a CSI report includes a number (e.g., K) of PMI segments indicating the same number less one (i.e., K−1) of time units or intervals, where a first of the number of PMI segments corresponds to a pre-defined or a pre-configured value of a time unit, as K−1 time values for K PMI segments. In another implementation, the time values are indicated in a form of a bitmap. For example, a UE is configured with reporting K PMI segments over K′ possible time units or intervals, where K≤K′, would report the K selected time intervals via a bitmap of length K′ that comprises K entries with a value of one that indicate a correspondence with the K reported PMI segments. In another example, a UE is configured with reporting K PMI segments over K′ possible time units/intervals, where K≤K′, would report K−1 selected time units or intervals via a bitmap of a length that includes K′−1 entries with a value of one that indicates a correspondence with a last K−1 reported PMI segments of the K PMI segments, and where a first report PMI segment of the K PMI segments corresponds to a pre-defined or pre-configured time unit or interval.

In an implementation for a combinatorial value to indicate time units, the time values are indicated in a form of a combinatorial parameter value. For example, a UE can be configured with reporting K PMI segments over K′ possible time units or intervals, where K≤K′, would report a value that indicates the K selected time units or intervals via a parameter with a bitwidth (i.e., a number of bits), equal to

$$⌈ {log}_{2} ( \begin{matrix}{K}^{′} \\ K\end{matrix} ) ⌉$$

bits (e.g., a ceiling function of a base-two logarithm of K′-choose-K function). In another example, a UE can be configured with reporting K PMI segments over K′ possible time units or intervals, where K≤K′, would report a value that indicates K−1 selected time units or intervals via a parameter with a bitwidth (i.e., number of bits) equal to

$$⌈ {log}_{2} ( \begin{matrix}{K}^{′} - 1 \\ K - 1\end{matrix} ) ⌉$$

bits (e.g., a ceiling function of a base-two logarithm of (K′−1)-choose-(K−1) function), that indicates a correspondence with a last K−1 reported PMI segments of the K PMI segments, and where a first report PMI segment of the K PMI segments corresponds to a pre-defined or pre-configured time unit or interval.

In another implementation, the K PMI segments can be grouped into two groups of K₁, K₂ PMI segments, respectively, where K=K₁+K₂, and a first of the two groups of PMI segments corresponds to time units or intervals that precede a time unit or interval at which the CSI report comprising the PMI segments is transmitted. A second of the two groups of PMI segments corresponds to time units or intervals that follow a time unit or interval at which the CSI report comprising the PMI segments is transmitted. For group 1, CSI corresponds to time x and the CSI report is transmitted at time z, where x<z (CSI from past measurements). For group 2, CSI corresponds to time y and the CSI report is transmitted at time z, where y>z (CSI predicted for future time). In a first example, the values K₁, K₂ are higher-layer configured by the network. In a second example, the values K₁, K₂ are selected by the UE and reported implicitly or explicitly as part of the CSI report. In a third example, two bitmaps are indicated as corresponding to the two groups of PMI segments. In a fourth example, two combinatorial parameter values are indicated as corresponding to the two groups of PMI segments.

In one or more implementations, the terms antenna, panel, and antenna panel are used interchangeably. An antenna panel may be hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may be an array of antenna elements, where each antenna element is coupled to hardware, such as a phase shifter that allows a control module to apply spatial parameters for transmission and/or reception of signals. The resulting radiation pattern may be called a beam, which may or may not be unimodal, and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE or a node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on the implementation of a device, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to a gNB. For certain condition(s), a gNB or the network can assume the mapping between physical antennas of a device to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels”. In an implementation, the device may support UL transmission from one beam within a panel, or with multiple panels, more than one beam (one beam per panel) may be used for UL transmission. In another implementation, more than one beam per panel may be supported or used for UL transmission.

In some of the implementations described, an antenna port is defined such that the channel over which a symbol on the antenna port is conveyed can be inferred from the channel over which another symbol on the same antenna port is conveyed. Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and a different subset of large-scale properties may be indicated by a QCL Type. The QCL Type can indicate which channel properties are the same between two reference signals (e.g., on the two antenna ports). Thus, the reference signals can be linked to each other with respect to what the UE can assume about their channel statistics or QCL properties. For example, qcl-Type may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}.

Spatial Rx parameters may include one or more of: angle of arrival (AoA,), dominant AoA, average AoA, angular spread, power angular spectrum (PAS) of AoA, average AoD (angle of departure), PAS of AoD, transmit/receive channel correlation, transmit/receive beamforming, spatial channel correlation, etc. The QCL-TypeA, QCL-TypeB, and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e. the UE would need to form beams for directional transmission. For QCL-TypeD between two reference signals A and B, the reference signal A is considered to be spatially co-located with reference signal B, and the UE may assume that the reference signals A and B can be received with the same spatial filter (e.g., with the same receive (RX) beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the described implementations, a transmission configuration indication (TCI)-state associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some of the described implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the described implementations, a UL TCI state is provided if a device is configured with separate DL/UL TCI by RRC signaling. The UL TCI state may include a source reference signal which provides a reference for determining an UL spatial domain transmission filter for the UL transmission (e.g., dynamic-grant/configured-grant based PUSCH, dedicated PUCCH resources) in a component carrier (CC) or across a set of configured CCs/BWPs.

In some of the described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/physical downlink shared channel (PDSCH)) and is used to determine an UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

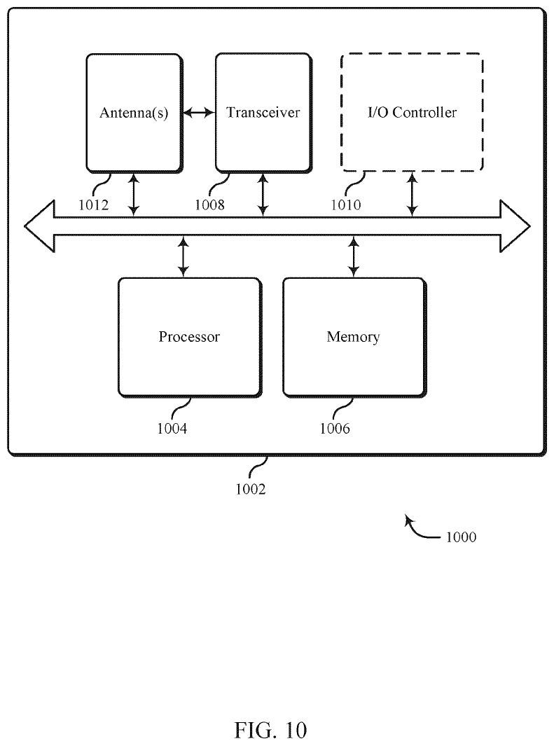

FIG. 9 illustrates an example of a block diagram 900 of a device 902 that supports timing for CSI reporting in accordance with aspects of the present disclosure. The device 902 may be an example of UE 104 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. The processor 904 may be configured as or otherwise support a means for receiving a first signaling indicating a CSI reporting setting, the CSI reporting setting indicating CSI-RS transmissions over a CMR, the CSI-RS transmissions associated with time units, the CSI-RS transmissions corresponding to two PMI segments; mapping at least one PMI segment of the two PMI segments to the time units; and transmitting a second signaling indicating a CSI report identifying the at least one PMI segment of the two PMI segments mapped to the time units.

Additionally, the processor 904 may be configured as or otherwise support any one or combination of each PMI segment of the two PMI segments comprises a set of coefficients. Each PMI segment of the two PMI segments is associated with at least one CSI-RS transmission of the CSI-RS transmissions. The CSI report further comprises a mapping of the at least one PMI segment of the two PMI segments to the time units. The mapping is indicated in a form of a selected value from a set of values corresponding to all possible mappings of the at least one PMI segment of the two PMI segments to the time units. The mapping is indicated in a form of a bitmap of a sequence of bits, each bit of the sequence of bits corresponding to at least one time unit of the time units. A first one-valued bit of the bitmap corresponds to a first PMI segment of the two PMI segments, and a second one-valued bit of the bitmap corresponds to a second PMI segment of the two PMI segments. A first one-valued bit of the bitmap corresponds to a second PMI segment of the two PMI segments, and a second one-valued bit of the bitmap corresponds to a third PMI segment. A first PMI segment of the two PMI segments corresponds to a reference time unit. The reference time unit corresponds to at least one of a first time unit of the time units, a time unit of the time units that is configured by a network, or a median time unit of the time units. The CSI-RS transmissions correspond to at least one of: CSI-RSs for channel measurement transmitted via a periodic time-domain behavior on a same CSI-RS resource over a plurality of symbol times; CSI-RSs for channel measurement transmitted via a semi-persistent time-domain behavior on the same CSI-RS resource over the plurality of symbol times; or CSI-RSs for channel measurement transmitted via an aperiodic time-domain behavior on multiple CSI-RS resources over the plurality of symbol times. The two PMI segments correspond to at least one of: two PMI quantities or PMI values; or two sets of non-zero coefficient values of a same PMI quantity or a same PMI value. A second PMI segment of the two PMI segments comprises a subset of parameters indicated in a first PMI segment of the two PMI segments. The time units are mapped to time slots corresponding to the CSI-RS transmissions. The time units are mapped to a plurality of time slots with equally-spaced time gaps. An initial value corresponding to a first time unit of the time units and the equally-spaced time gaps is at least one of indicated in the CSI report or higher-layer configured by a network device. The time units are decomposed into at least one of two subsets of the time units, wherein time units of a first subset of the time units are associated with time slots that precede a time slot corresponding to a CSI reporting time, and time units of a second subset of the time units are associated with additional time slots that succeed the time slot corresponding to the CSI reporting time.

Additionally, or alternatively, the device 902, in accordance with examples as disclosed herein, is an apparatus that may include a processor; a transceiver coupled with the processor; and a memory coupled with the processor, the processor and the transceiver configured to: receive a first signaling indicating a CSI reporting setting, the CSI reporting setting indicating CSI-RS transmissions over a CMR, the CSI-RS transmissions associated with time units, the CSI-RS transmissions corresponding to two PMI segments; map at least one PMI segment of the two PMI segments to the time units; and transmit a second signaling indicating a CSI report identifying the at least one PMI segment of the two PMI segments mapped to the time units.

Additionally, the wireless communication at the device 902 may include any one or combination of each PMI segment of the two PMI segments comprises a set of coefficients. Each PMI segment of the two PMI segments is associated with at least one CSI-RS transmission of the CSI-RS transmissions. The CSI report further comprises a mapping of the at least one PMI segment of the two PMI segments to the time units. The mapping is indicated in a form of a selected value from a set of values corresponding to all possible mappings of the at least one PMI segment of the two PMI segments to the time units. The mapping is indicated in a form of a bitmap of a sequence of bits, each bit of the sequence of bits corresponding to at least one time unit of the time units. A first one-valued bit of the bitmap corresponds to a first PMI segment of the two PMI segments, and a second one-valued bit of the bitmap corresponds to a second PMI segment of the two PMI segments. A first one-valued bit of the bitmap corresponds to a second PMI segment of the two PMI segments, and a second one-valued bit of the bitmap corresponds to a third PMI segment. A first PMI segment of the two PMI segments corresponds to a reference time unit. The reference time unit corresponds to at least one of a first time unit of the time units, a time unit of the time units that is configured by a network, or a median time unit of the time units. The CSI-RS transmissions correspond to at least one of CSI-RSs for channel measurement transmitted via a periodic time-domain behavior on a same CSI-RS resource over a plurality of symbol times; CSI-RSs for channel measurement transmitted via a semi-persistent time-domain behavior on the same CSI-RS resource over the plurality of symbol times; or CSI-RSs for channel measurement transmitted via an aperiodic time-domain behavior on multiple CSI-RS resources over the plurality of symbol times. The two PMI segments correspond to at least one of: two PMI quantities or PMI values; or two sets of non-zero coefficient values of a same PMI quantity or a same PMI value. A second PMI segment of the two PMI segments comprises a subset of parameters indicated in a first PMI segment of the two PMI segments. The time units are mapped to time slots corresponding to the CSI-RS transmissions. The time units are mapped to a plurality of time slots with equally-spaced time gaps. An initial value corresponding to a first time unit of the time units and the equally-spaced time gaps is at least one of indicated in the CSI report or higher-layer configured by a network device. The time units are decomposed into at least one of two subsets of the time units, wherein time units of a first subset of the time units are associated with time slots that precede a time slot corresponding to a CSI reporting time, and time units of a second subset of the time units are associated with additional time slots that succeed the time slot corresponding to the CSI reporting time.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

FIG. 10 illustrates an example of a block diagram 1000 of a device 1002 that supports timing for CSI reporting in accordance with aspects of the present disclosure. The device 1002 may be an example of a network entity 102 (e.g., a base station) as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006).

For example, the processor 1004 may support wireless communication at the device 1002 in accordance with examples as disclosed herein. The processor 1004 may be configured as or otherwise support a means for transmitting a first signaling indicating a CSI reporting setting, the CSI reporting setting indicating CSI-RS transmissions over a CMR, the CSI-RS transmissions associated with time units, the CSI-RS transmissions corresponding to two PMI segments; and receiving a second signaling indicating a CSI report identifying a mapping of at least one PMI segment of the two PMI segments mapped to the time units.

Additionally, the processor 1004 may be configured as or otherwise support any one or combination of each PMI segment of the two PMI segments comprises a set of coefficients. Each PMI segment of the two PMI segments is associated with at least one CSI-RS transmission of the CSI-RS transmissions. The CSI report further comprises the mapping of the at least one PMI segment of the two PMI segments to the time units. The mapping is indicated in a form of a selected value from a set of values corresponding to all possible mappings of the at least one PMI segment of the two PMI segments to the time units. The mapping is indicated in a form of a bitmap of a sequence of bits, each bit of the sequence of bits corresponding to at least one time unit of the time units. A first one-valued bit of the bitmap corresponds to a first PMI segment of the two PMI segments, and a second one-valued bit of the bitmap corresponds to a second PMI segment of the two PMI segments. A first one-valued bit of the bitmap corresponds to a second PMI segment of the two PMI segments, and a second one-valued bit of the bitmap corresponds to a third PMI segment. A first PMI segment of the two PMI segments corresponds to a reference time unit. The reference time unit corresponds to at least one of a first time unit of the time units, a time unit of the time units that is configured by a network, or a median time unit of the time units. The CSI-RS transmissions correspond to at least one of: CSI-RSs for channel measurement transmitted via a periodic time-domain behavior on a same CSI-RS resource over a plurality of symbol times; CSI-RSs for channel measurement transmitted via a semi-persistent time-domain behavior on the same CSI-RS resource over the plurality of symbol times; or CSI-RSs for channel measurement transmitted via an aperiodic time-domain behavior on multiple CSI-RS resources over the plurality of symbol times. The two PMI segments correspond to at least one of: two PMI quantities or PMI values; or two sets of non-zero coefficient values of a same PMI quantity or a same PMI value. A second PMI segment of the two PMI segments comprises a subset of parameters indicated in a first PMI segment of the two PMI segments. The time units are mapped to time slots corresponding to the CSI-RS transmissions. The time units are mapped to a plurality of time slots with equally-spaced time gaps. An initial value corresponding to a first time unit of the time units and the equally-spaced time gaps is at least one of indicated in the CSI report or higher-layer configured by a network device. The time units are decomposed into at least one of two subsets of the time units, wherein time units of a first subset of the time units are associated with time slots that precede a time slot corresponding to a CSI reporting time, and time units of a second subset of the time units are associated with additional time slots that succeed the time slot corresponding to the CSI reporting time.

Additionally, or alternatively, the device 1002, in accordance with examples as disclosed herein, is an apparatus that may include a processor; a transceiver coupled with the processor; and a memory coupled with the processor, the processor and the transceiver configured to: transmit a first signaling indicating a CSI reporting setting, the CSI reporting setting indicating CSI-RS transmissions over a CMR, the CSI-RS transmissions associated with time units, the CSI-RS transmissions corresponding to two PMI segments; and receive a second signaling indicating a CSI report identifying a mapping of at least one PMI segment of the two PMI segments mapped to the time units.

Additionally, the wireless communication at the device 1002 may include any one or combination of each PMI segment of the two PMI segments comprises a set of coefficients. Each PMI segment of the two PMI segments is associated with at least one CSI-RS transmission of the CSI-RS transmissions. The CSI report further comprises the mapping of the at least one PMI segment of the two PMI segments to the time units. The mapping is indicated in a form of a selected value from a set of values corresponding to all possible mappings of the at least one PMI segment of the two PMI segments to the time units. The mapping is indicated in a form of a bitmap of a sequence of bits, each bit of the sequence of bits corresponding to at least one time unit of the time units. A first one-valued bit of the bitmap corresponds to a first PMI segment of the two PMI segments, and a second one-valued bit of the bitmap corresponds to a second PMI segment of the two PMI segments. A first one-valued bit of the bitmap corresponds to a second PMI segment of the two PMI segments, and a second one-valued bit of the bitmap corresponds to a third PMI segment. A first PMI segment of the two PMI segments corresponds to a reference time unit. The reference time unit corresponds to at least one of a first time unit of the time units, a time unit of the time units that is configured by a network, or a median time unit of the time units. The CSI-RS transmissions correspond to at least one of: CSI-RSs for channel measurement transmitted via a periodic time-domain behavior on a same CSI-RS resource over a plurality of symbol times; CSI-RSs for channel measurement transmitted via a semi-persistent time-domain behavior on the same CSI-RS resource over the plurality of symbol times; or CSI-RSs for channel measurement transmitted via an aperiodic time-domain behavior on multiple CSI-RS resources over the plurality of symbol times. The two PMI segments correspond to at least one of: two PMI quantities or PMI values; or at least two sets of non-zero coefficient values of a same PMI quantity or a same PMI value. A second PMI segment of the two PMI segments comprises a subset of parameters indicated in a first PMI segment of the two PMI segments. The time units are mapped to time slots corresponding to the CSI-RS transmissions. The time units are mapped to a plurality of time slots with equally-spaced time gaps. An initial value corresponding to a first time unit of the time units and the equally-spaced time gaps is at least one of indicated in the CSI report or higher-layer configured by a network device. The time units are decomposed into at least one of two subsets of the time units, wherein time units of a first subset of the time units are associated with time slots that precede a time slot corresponding to a CSI reporting time, and time units of a second subset of the time units are associated with additional time slots that succeed the time slot corresponding to the CSI reporting time.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device M02. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor 1004. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (i.e., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

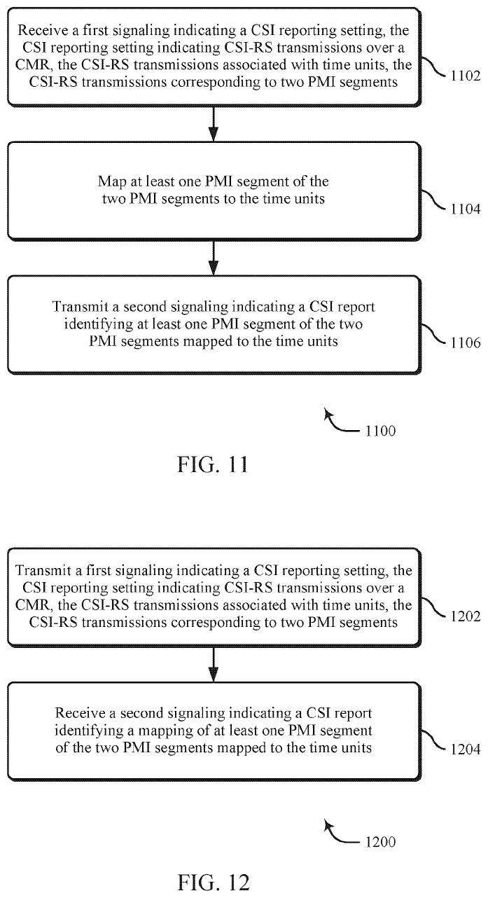

FIG. 11 illustrates a flowchart of a method 1100 that supports timing for CSI reporting in accordance with aspects of the present disclosure. The operations of the method 1100 may be implemented by a device or its components as described herein. For example, the operations of the method 1100 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1102, the method may include receiving a first signaling indicating a CSI reporting setting, the CSI reporting setting indicating CSI-RS transmissions over a CMR, the CSI-RS transmissions associated with time units, the CSI-RS transmissions corresponding to two PMI segments. The operations of 1102 may be performed in accordance with examples as described herein. In some implementations, aspects of the operations of 1102 may be performed by a device as described with reference to FIG. 1.

At 1104, the method may include mapping at least one PMI segment of the two PMI segments to the time units. The operations of 1104 may be performed in accordance with examples as described herein. In some implementations, aspects of the operations of 1104 may be performed by a device as described with reference to FIG. 1.

At 1106, the method may include transmitting a second signaling indicating a CSI report identifying at least one PMI segment of the two PMI segments mapped to the time units. The operations of 1106 may be performed in accordance with examples as described herein. In some implementations, aspects of the operations of 1106 may be performed by a device as described with reference to FIG. 1.

FIG. 12 illustrates a flowchart of a method 1200 that supports timing for CSI reporting in accordance with aspects of the present disclosure. The operations of the method 1200 may be implemented by a device or its components as described herein. For example, the operations of the method 1200 may be performed by a network entity 102 (e.g., a base station) as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1202, the method may include transmitting a first signaling indicating a CSI reporting setting, the CSI reporting setting indicating CSI-RS transmissions over a CMR, the CSI-RS transmissions associated with time units, the CSI-RS transmissions corresponding to two PMI segments. The operations of 1202 may be performed in accordance with examples as described herein. In some implementations, aspects of the operations of 1202 may be performed by a device as described with reference to FIG. 1.

At 1204, the method may include receiving a second signaling indicating a CSI report identifying a mapping of at least one PMI segment of the two PMI segments mapped to the time units. The operations of 1204 may be performed in accordance with examples as described herein. In some implementations, aspects of the operations of 1204 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory;
at least one processor coupled with the at least one memory and configured to cause the UE to:
receive a first signaling indicating a channel state information (CSI) reporting setting, the CSI reporting setting indicating CSI-reference signal (RS) transmissions over a channel measurement resource (CMR), the CSI-RS transmissions associated with time units, the CSI-RS transmissions corresponding to two precoder matrix indicator (PMI) segments;
map at least one PMI segment of the two PMI segments to the time units; and
transmit a second signaling indicating a CSI report identifying the at least one PMI segment of the two PMI segments mapped to the time units.

2. The UE of claim 1, wherein each PMI segment of the two PMI segments comprises a set of coefficients.

3. The UE of claim 1, wherein each PMI segment of the two PMI segments is associated with at least one CSI-RS transmission of the CSI-RS transmissions.

4. The UE of claim 1, wherein the CSI report further comprises a mapping of the at least one PMI segment of the two PMI segments to the time units.

5. The UE of claim 4, wherein the mapping is indicated in at least one form of:
a selected value from a set of values corresponding to all possible mappings of the at least one PMI segment of the two PMI segments to the time units; or
a bitmap of a sequence of bits, each bit of the sequence of bits corresponding to at least one time unit of the time units.

6. The UE of claim 1, wherein a first PMI segment of the two PMI segments corresponds to a reference time unit that corresponds to at least one of a first time unit of the time units, a time unit of the time units that is configured by a network, or a median time unit of the time units.

7. The UE of claim 1, wherein the CSI-RS transmissions correspond to at least one of:
CSI-RSs for channel measurement transmitted via a periodic time-domain behavior on a same CSI-RS resource over a plurality of symbol times;
CSI-RSs for the channel measurement transmitted via a semi-persistent time-domain behavior on the same CSI-RS resource over the plurality of symbol times; or
CSI-RSs for the channel measurement transmitted via an aperiodic time-domain behavior on multiple CSI-RS resources over the plurality of symbol times.

8. The UE of claim 1, wherein the two PMI segments correspond to at least one of:
two PMI quantities or PMI values; or
two sets of non-zero coefficient values of a same PMI quantity or a same PMI value.

9. The UE of claim 1, wherein the time units are mapped to time slots corresponding to the CSI-RS transmissions.

10. The UE of claim 1, wherein the time units are mapped to a plurality of time slots with equally-spaced time gaps.

11. The UE of claim 10, wherein an initial value corresponding to a first time unit of the time units and the equally-spaced time gaps is at least one of indicated in the CSI report or higher-layer configured by a network device.

12. The UE of claim 1, wherein the time units are decomposed into at least one of two subsets of the time units, wherein time units of a first subset of the time units are associated with time slots that precede a time slot corresponding to a CSI reporting time, and time units of a second subset of the time units are associated with additional time slots that succeed the time slot corresponding to the CSI reporting time.

13. A network entity (NE) for wireless communication, comprising:
at least one memory; and
at least one processor coupled with the at least one memory and configured to cause the NE to:
transmit a first signaling indicating a channel state information (CSI) reporting setting, the CSI reporting setting indicating CSI-reference signal (RS) transmissions over a channel measurement resource (CMR), the CSI-RS transmissions associated with time units, the CSI-RS transmissions corresponding to two precoder matrix indicator (PMI) segments; and
receive a second signaling indicating a CSI report identifying a mapping of at least one PMI segment of the two PMI segments mapped to the time units.

14. (canceled)

15. A method performed by a user equipment (UE), the method comprising:
receiving a first signaling indicating a channel state information (CSI) reporting setting, the CSI reporting setting indicating CSI-reference signal (RS) transmissions over a channel measurement resource (CMR), the CSI-RS transmissions associated with time units, the CSI-RS transmissions corresponding to two precoder matrix indicator (PMI) segments;
mapping at least one PMI segment of the two PMI segments to the time units; and
transmitting a second signaling indicating a CSI report identifying the at least one PMI segment of the two PMI segments mapped to the time units.

16-20. (canceled)

21. A processor for wireless communication, comprising:
at least one controller coupled with at least one memory and configured to cause the processor to:
receive a first signaling indicating a channel state information (CSI) reporting setting, the CSI reporting setting indicating CSI-reference signal (RS) transmissions over a channel measurement resource (CMR), the CSI-RS transmissions associated with time units, the CSI-RS transmissions corresponding to two precoder matrix indicator (PMI) segments;
map at least one PMI segment of the two PMI segments to the time units; and
transmit a second signaling indicating a CSI report identifying the at least one PMI segment of the two PMI segments mapped to the time units.

22. The processor of claim 21, wherein each PMI segment of the two PMI segments comprises a set of coefficients.

23. The processor of claim 21, wherein a first PMI segment of the two PMI segments corresponds to a reference time unit that corresponds to at least one of a first time unit of the time units, a time unit of the time units that is configured by a network, or a median time unit of the time units.

24. The processor of claim 21, wherein the two PMI segments correspond to at least one of:
two PMI quantities or PMI values; or
two sets of non-zero coefficient values of a same PMI quantity or a same PMI value.

25. The processor of claim 21, wherein the time units are mapped to a plurality of time slots with equally-spaced time gaps.

26. The processor of claim 25, wherein an initial value corresponding to a first time unit of the time units and the equally-spaced time gaps is at least one of indicated in the CSI report or higher-layer configured by a network device.
